(19) United States
(12) Patent Application Publication
(10) Pub. No.: US 2017/0341695 A1
(43) Pub. Date: Nov. 30, 2017

(54) Bicycle Fairing

(71) Applicant: Gip Noble, JR., Hesperia, CA (US)

(72) Inventor: Gip Noble, JR., Hesperia, CA (US)

(21) Appl. No.: 15/418,594

(22) Filed: Jan. 27, 2017

Related U.S. Application Data
(60) Provisional application No. 62/287,681, filed on Jan. 27, 2016.

(51) Int. Cl. B62J 17/02

(52) U.S. Cl. CPC B62J 17/02

(57) ABSTRACT

A bicycle fairing for reducing drag created by a bicycle rider on a bicycle is provided. The bicycle has a bicycle frame mounted between a front wheel and a rear wheel and handlebars adjacent the front wheel. The bicycle fairing comprises a hollow cone-shaped windshield having an open base end and a pointed closed tip end. A mounting assembly mounts the windshield to the handlebars of the bicycle over at least a portion of the front wheel. The windshield extends substantially horizontally over at least a portion of the front wheel of the bicycle with the cone tip end of the windshield facing in a generally forward direction away from the bicycle rider. The windshield deflects air in an approximately three hundred sixty degree pattern creating a pocket of low air resistance around an upper portion of the bicycle rider thereby reducing drag.

### CLAIM OF PRIORITY

This patent application claims priority under 35 USC 119 (e) (1) from U.S. Provisional Patent Application Ser. No. 62/287,681filed Jan. 27, 2016, of common inventorship herewith entitled, “Speed Cone,” which is incorporated herein by reference as though the same were set forth In its entirety.

### FIELD OF THE INVENTION

The present invention pertains to the field of road cycling, and more specifically to the field of front fairings for bicycles.

### BACKGROUND OF THE INVENTION

Riding a bicycle is one of those things that an individual learns once and never forgets. Optimally, it is best to ride a bike early in one's life when learning comes easiest. The pleasures and benefits of bicycling are great, ranging from improved physical fitness and cardiovascular health to an independence and competence gained by getting from one place to another by any chosen route, completely on one's own physical capacity and endurance. Bicycles provide cyclists with an enjoyable means of exercise freedom, responsibility, and escape. Bicycles today are more specialized, sophisticated and expensive than they were in the past. Bicycle enthusiasts and engineers are always pushing the envelope of technology to create a bike that is faster lighter, tougher, and more capable. For speed, nothing beats a lightweight road bike and riders of road bikes are always seeking a way to go faster and farther while expending less effort.

The prior art has put forth several designs for front fairings for bicycles. Among these are:

U.S. Pat. No. 4,066,290 to Gerald A. Wiegert describes a streamlined, lightweight fairing that is attachable to handles of a bicycle by a pair of mounting rods forming a rigid and stable mounting structure that is further attachable by clamps to the front wheel fork. The fairing presents a streamlined rounded surface to the front of the bicycle and a relatively large concave enclosure to the rear, to cover the upper portions of the bicycle and rider as viewed from the front. An integral fender substantially increases the size of the enclosure, arcuate trailing edges facilitate positioning of the rider's head and hands behind the fairing, and transparent windows are included for forward and downward visibility.

U.S. Pat. No. 4,022,487 to William F Leahy describes a bicycle fairing comprising a unitary molded body carrying a transparent windshield, brace means for securing said fairing body to the handlebars of a bicycle and a bracket which enables securement of the body of the fairing to the fork holder of the bicycle and positions the fairing properly relative to the bicycle to enable proper securement of the brace means thereto. The bracket comprises a planar mid portion and a pair of end bends, respectively extending in opposed directions but in parallel planes. The single bracket receives the fork holder of the bicycle through a passage formed in one end bend so that the coupling means which secures the fork holder to the bicycle frame can be used to complete the assembly of fairing body to the bicycle. The length of the mid portion of the bracket is selected to enable coupling of the fairing to a bicycle or to the so called high rise model by an approximate one hundred eighty degree rotation of the bracket about its axis. The opposite bend is provided with suitable passageways capable of matching with similar passageways formed in the fairing to enable passage of fastening means there through.

U.S. Pat. No. 3,891,265 to James R. Blackburn describes a wind screen fairing for attachment to the handlebars of a bicycle to protect hands, torso and face of a bicycle rider. The fairing comprises a sheet fabricated of a clear, flexible material that includes a top edge and a bottom edge. Each edge is aligned in a substantially horizontal direction and arranged such that a line bisecting the top and bottom edges defines a vertical reference line and a line passing through the sheet, intermediate the top and bottom edges and normal to the vertical reference line, defines a horizontal reference line. The sheet further includes first and second slots, respectively extending along the horizontal reference line from the respective side edges of the sheet inwardly toward one another. A first pair of apertures are disposed respectively above and below the first slot and a second pair of apertures are disposed respectively below the second slot. Brackets are included for aligning the apertures of the first pair, aligning the apertures of the second pair and securing the sheet to the handlebars. The respective alignments of the pairs of apertures are operative to produce a cross curvature of said sheet along the horizontal reference line and the vertical reference line, bowing the sheet into a generally concave configuration.

None of these prior art references describe the present invention.

### SUMMARY OF THE INVENTION

It is an object of the present invention to provide an aerodynamic, transparent, cone shaped fairing or windshield for bicycles that is particularly effective in reducing drag on road bikes, thereby permitting a rider to move faster with relatively less effort, the very definition of cycling efficiency.

The present invention is a bicycle fairing for reducing drag created by a bicycle rider on a bicycle. The bicycle has a bicycle mounted between a front wheel and a rear wheel and handlebars adjacent the front wheel. T he bicycle fairing comprises a hollow cone-shaped windshield having an open base end and a pointed closed tip end. A mounting assembly mounts the windshield to the handlebars of the bicycle over at least a portion of the front wheel. The windshield extends substantially horizontally over at least a portion of the front wheel of the bicycle with the cone tip end of the windshield facing in a generally forward direction away from the bicycle rider. The windshield deflects air in an approximately three hundred sixty degree pattern creating a pocket of low air resistance around an upper portion of the bicycle rider thereby reducing drag.

In addition the present invention includes a method for reducing drag created by a bicycle rider on a bicycle. The bicycle has a bicycle frame mounted between a front wheel and a rear wheel and handlebars adjacent the front wheel. The method comprises providing a hollow cone-shaped windshield having an open base end and a pointed closed tip end, extending the windshield substantially horizontally over at least a portion of the front wheel of the bicycle with the cone tip end of the windshield facing in a generally forward direction away from the bicycle rider, mounting the windshield to the handlebars of the bicycle over at least a portion of the front wheel, deflecting air in an approximately three hundred sixty degree pattern, and creating a pocket of low air resistance around an upper portion of the bicycle rider thereby reducing drag.

The present invention further includes a bicycle fairing for reducing drag created by a bicycle rider on a bicycle. The bicycle having a bicycle frame mounted between a front wheel and a rear wheel and handlebars adjacent the front wheel. The bicycle fairing comprises a transparent, hollow cone-shaped windshield having an open base end and a pointed dosed tip end. A first mounting bracket having a first mounting arm and a first mounting clamp is provided with the first mounting arm having a first end and a second end and the first mounting clamp secured to the second end of the first mounting arm. A second mounting bracket is provided having a second mounting arm and a second mounting clamp with the second mounting arm having a first end and a second end and the second mounting clamp secured to the second end of the second mounting arm. The first mounting bracket and the second mounting bracket are secured to the windshield and the first mounting clamp and the second mounting clamp are secured to the handlebars. The windshield extends substantially horizontally over at least a portion of the front wheel of the bicycle with the cone tip end of the windshield facing In a generally forward direction away from the bicycle rider. The windshield deflects air in an approximately three hundred sixty degree pattern creating a pocket of low air resistance around an upper portion of the bicycle rider thereby reducing drag.

### BRIEF DESCRIPTION OF THE DRAWINGS

FIG. 1 is a perspective view illustrating a bicycle fairing, constructed in accordance with the present invention, showing a cone-shaped windshield and mounting brackets for releasable securement to handlebars of a bicycle.

FIG. 2 is a perspective view illustrating the bicycle fairing, constructed in accordance with the present Invention, with the cone-shaped windshield releasably secured to the handlebars of a bicycle by means of the mounting brackets.

FIG. 3 is an elevational side view illustrating the bicycle fairing, constructed in accordance with the present invention, with the cone-shaped windshield releasably secured to the handlebars of a bicycle by means of the mounting brackets.

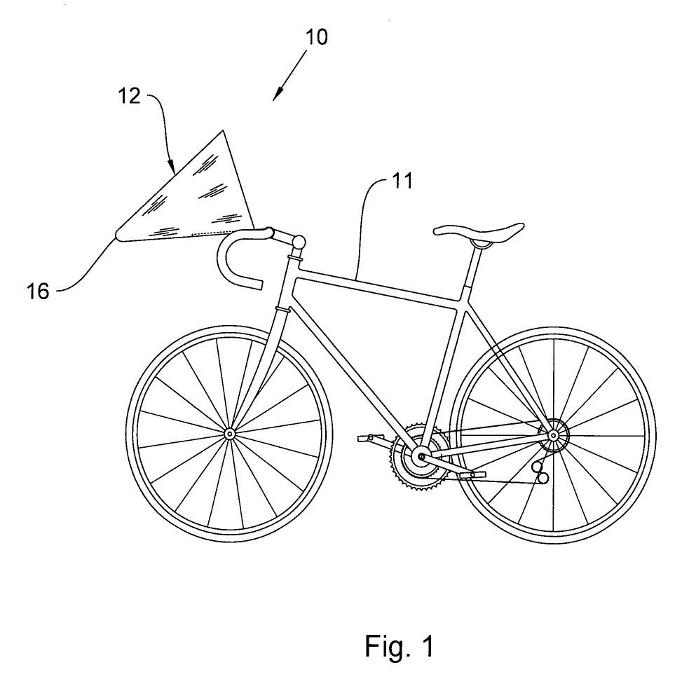

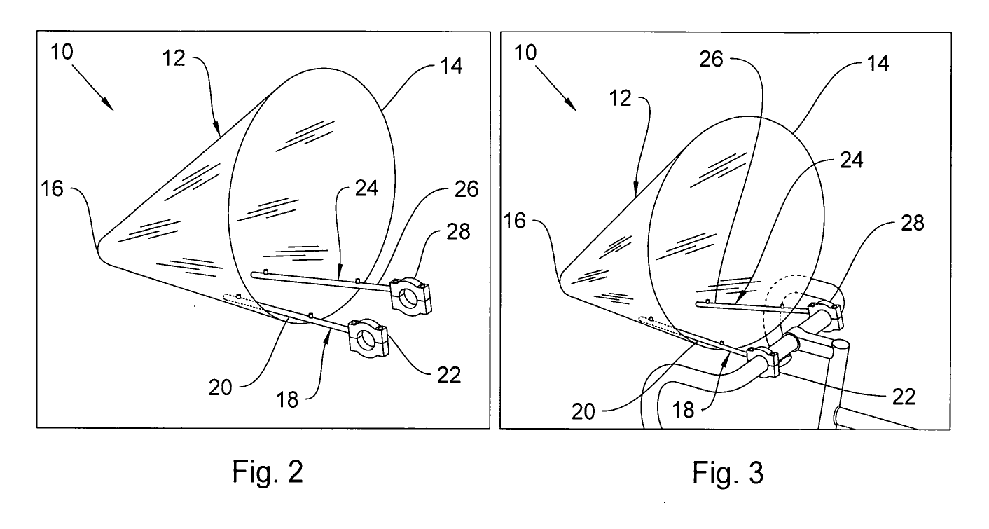

### DETAILED DESCRIPTION OF THE INVENTION

The present invention, hereinafter referred to as a Bicycle Fairing, indicated generally at 10, is an aerodynamic, transparent, cone-shaped fairing or windshield for bicycles 11, particularly functional for road bikes. The Bicycle Fairing 10 reduces drag, thereby permitting a rider to move faster with relatively less effort, the very definition of cycling efficiency. By simply leaning forward such that one's head is within the transparent, fog free Bicycle Fairing 10, the conical shape of the Bicycle Fairing 10 functions to reduce drag and move a cyclist more gently and easily through the air.

The Bicycle Fairing 10 of the present invention includes a hollow cone-shaped windshield 12 having a wide open base end 14 and a tip end 16. Preferably, the tip end 16 of the windshield is pointed and closed. The windshield 12 is preferably constructed from a Lexan polycarbonate resin measuring one thirty seconds ( 1/32″) inch in thickness. Preferably, the windshield 12 of the Bicycle Fairing 10 measures approximately twenty tour (24″) inches in length and approximately eighteen (18″) inches in diameter at the base end.

As mentioned, the windshield 12 of the Bicycle Fairing 10 of the present invention is cone-shaped. In an embodiment, the cone-shaped windshield 12 is in the shape of an oblique circular cone in which the base end 14 of the windshield 12 is a circle and an axis of the windshield 12 passes through a center of the base end 14 non-perpendicularly to a plane of the base end 14. In an alternative embodiment, the cone-shaped windshield 12 is in the shape of a right circular cone in which the axis of the windshield 12 passes through the center of the base end 14 at right angles to the plane of the base end 14. In general however, it is within the scope of the present invention for the base end 14 to be any shape, as desired by the manufacturer and user.

The Bicycle Fairing 10 of the present invention further includes a mounting assembly for mounting the windshield 12 to the handlebars of the bicycle. In a preferred embodiment, the mounting assembly includes a first mounting bracket 18 having a first mounting arm 20 and a first mounting clamp 22 and a second mounting bracket 24 having a second mounting arm 26 and a second mounting clamp 28. The first mounting arm 18 has a first end and a second end and the second mounting arm 24 has a first end and a second end. The first mounting damp 22 is secured to the second end of the first mounting arm 20 and the second mounting clamp 28 is secured to the second end of the second mounting arm 26.

Preferably, the first mounting bracket 18 and the second mounting bracket 24 of the Bicycle Fairing 10 of the present invention are secured within the windshield 12 such that the first mounting arm 20 of the first mounting bracket 18 is spaced from and substantially parallel to the second mounting arm 26 of the second mounting bracket 24. The first end of the first mounting arm 20 is secured within the windshield 20 with the second end of the first mounting arm 20 and the first mounting clamp 22 extending beyond the base end 14 of the windshield 12 to a point outside the windshield 14. The first end of the second mounting arm 28 is secured within the windshield 12 with the second end of the second mounting arm 26 and the second mounting clamp 28 extending beyond the base end 14 of the windshield 12 to a point outside the windshield 12.

In a preferred embodiment, the Bicycle Fairing 10 of the present invention includes the second end of the first mounting arm 20 and the first mounting clamp 22 positioned outside the windshield 12 beyond the base end 14 of the windshield 12 and the second mounting bracket 24 is secured within the interior of the windshield 12

with the second end of the second mounting arm 26 and the second mounting clamp 28 positioned outside the windshield 12 beyond the base end 14 of the windshield 12. The actual extent of the second ends of the first and second mounting arms 20, 26 outside the windshield 12 is adjustable such that the user can position a greater or lesser amount of extension of the second ends, as desired.

The windshield 12 of the Bicycle Fairing 10 of the present invention is mounted to the bicycle 11 such that a bottom side of the windshield 12 extends substantially horizontally over the front wheel of the bicycle 11, so that the cone tip end 16 of the windshield 12 faces forward to form a highly aerodynamic windshield 12. The Bicycle Fairing 10 includes the cone windshield 12 along with necessary mounting hardware, preferably the first and second mounting arms 20, 26 and the first and second mounting brackets 22, 28 that are adjustable to fit various sizes of handlebars and riders.

For optimum functioning, a cyclist simply leans their head forward within the proximal open base end 14 of the transparent, fog-free windshield 12 of the Bicycle Fairing 10 of the present invention. The conical shape of the windshield 12 enables the Bicycle Fairing 10 to move gently and easily through the air and reduces drag. The aerodynamic shape of the Bicycle Fairing 10 deflects air in an approximately three hundred sixty degree pattern to create a pocket of low air resistance around the rider's chest and torso. Because the cyclist's drag is reduced, two improvements in performance result. First, the cyclist can ride farther or faster with no increase in effort. Second, with increased effort, the cyclist can ride farther or faster on a given bicycle than they ever have in the past.

The Bicycle Fairing 10 of the present invention improves the cyclist's efficiency by decreasing drag. Cyclists will find the Bicycle Fairing 10 to be an exceptionally useful and affordable accessory that pays off big in terms of performance. Durably constructed, lightweight, easily installed, and providing the rider with full and fog free visibility, the Bicycle Fairing 10 will withstand many years of helping a cyclist go faster with less effort.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A bicycle fairing for reducing drag created by a bicycle rider on a bicycle, the bicycle having a bicycle frame mounted between a front wheel and a rear wheel and handlebars adjacent the front wheel, the bicycle fairing comprising:
a hollow cone-shaped windshield having an open base end and a pointed closed tip end;
a mounting assembly for mounting the windshield to the handlebars of the bicycle over at least a portion of the front wheel:
wherein the windshield extends substantially horizontally over at least a portion of the front wheel of the bicycle, the cone tip end of the windshield facing in a generally forward direction away from the bicycle rider; and
wherein the windshield deflects air in an approximately three hundred sixty degree pattern creating a pocket of low air resistance around an upper portion of the bicycle rider thereby reducing drag

2. The bicycle fairing of claim 1 wherein the windshield is transparent

3. The bicycle fairing of claim 1 wherein the windshield is constructed from a Lexan polycarbonate resin.

4. The bicycle fairing of claim 1 wherein the cone-shaped windshield has a shape of an oblique circular cone

5. The bicycle fairing of claim 1 wherein the cone-shaped windshield is in the shape of a right circular cone

6. The bicycle fairing of claim 1 wherein the open base end is substantially circular.

7. The bicycle fairing of claim 1 wherein the open base end is substantially oval.

8. The bicycle fairing of claim 1 wherein the mounting assembly further comprises:
a first mounting bracket having a first mounting arm and a first mounting clamp, the first mounting arm having a first end
and a second end, the first mounting clamp secured to the second end of the first mounting arm; and
a second mounting bracket having a second mounting arm and a second mounting clamp, the second mounting arm having a first end and a second end, the second mounting clamp secured to the second end of the second mounting arm;
wherein the first mounting bracket and the second mounting bracket are secured to the windshield and the first mounting clamp and the second mounting clamp are secured to the handlebars such that the first mounting arm of the first mounting bracket is spaced from and substantially parallel to the second mounting arm of the second mounting bracket.

9. The bicycle fairing of claim 8 wherein the first end of the first mounting arm is secured within the windshield and the second end of the first mounting arm and the first mounting clamp extend beyond the base end of the windshield to a point outside the windshield, and wherein the first end of the second mounting arm is secured within the windshield with the second end of the second mounting arm and the second mounting clamp extend beyond the base end of the windshield to a point outside the windshield.

10. The bicycle fairing of claim 8 wherein a length of the first mounting arm and a length of the second mounting arm Is adjustable.

11. The bicycle fairing of claim 8 wherein the first mounting bracket and the second mounting bracket are adjustable

12. A method for reducing drag created by a bicycle rider on a bicycle, the bicycle having a bicycle frame mounted between a front wheel and a rear wheel and handlebars adjacent the front wheel, the method comprising.
providing a hollow cone-shaped windshield having an open base end and a pointed closed tip end:
extending the windshield substantially horizontally over at least a portion of the front wheel of the bicycle with the cone tip end of the windshield facing in a generally forward direction away from the bicycle rider;
mounting the windshield to the handlebars of the bicycle over at least a portion of the front wheel
deflecting air in an approximately three hundred sixty degree pattern; and
creating a pocket of low air resistance around an upper portion of the bicycle rider thereby reducing drag.

13. A bicycle fairing for reducing drag created by a bicycle rider on a bicycle, the bicycle having a bicycle frame mounted between a front wheel and a rear wheel and handlebars adjacent the front wheel; the bicycle fairing comprising:
a transparent, hollow cone-shaped windshield having an open base end and a pointed closed tip end;
a first mounting bracket having a first mounting arm and a first mounting clamp, the first mounting arm having a first end and a second end, the first mounting clamp secured to the second end of the first mounting arm; and
a second mounting bracket having a second mounting arm and a second mounting clamp, the second mounting arm having a first end and a second end, the second mounting clamp secured to the second end of the second mounting arm;
wherein the first mounting bracket and the second mounting bracket are secured to the windshield and the first mounting clamp and the second mounting clamp are secured to the handlebars;
wherein the windshield extends substantially horizontally over at least a portion of the front wheel of the bicycle, the cone tip end of the windshield facing in a generally forward direction away from the bicycle rider; and
wherein the windshield deflects air in an approximately three hundred sixty degree pattern creating a pocket of low air resistance around an upper portion of the bicycle rider thereby reducing drag.

14. The bicycle fairing of claim 13 wherein the cone-shaped windshield has a shape of an oblique circular cone.

15. The bicycle fairing of claim 13 wherein the cone-shaped windshield is in the shape of a right circular cone.

16. The bicycle fairing of claim 13 wherein the first mounting arm of the first mounting bracket is spaced from and substantially parallel to the second mounting arm of the second mounting bracket.

17. The bicycle fairing of claim 13 wherein the first end of the first mounting arm is secured within the windshield and the second end of the first mounting arm and the first mounting clamp extend beyond the base end of the windshield to a point outside the windshield, and wherein the first end of the second mounting arm is secured within the windshield with the second end of the second mounting arm and the second mounting clamp extend beyond the base end of the windshield to a point outside the windshield.

18. The bicycle fairing of claim 13 wherein a length of the first mounting arm and a length of the second mounting arm is adjustable.

19. The bicycle fairing of claim 13 wherein the first mounting bracket and the second mounting bracket are adjustable.

20. The bicycle fairing of claim 13 wherein the open base end is substantially circular.
